(19) United States
(12) Patent Application Publication
(10) Pub. No.: US 2025/0199275 A1
(43) Pub. Date: Jun. 19, 2025

(54) ZOOM OPTICAL SYSTEM, OPTICAL APPARATUS, AND METHOD FOR MANUFACTURING ZOOM OPTICAL SYSTEM

(71) Applicant: NIKON CORPORATION, Shinagawa-ku, Tokyo (JP)

(72) Inventors: Tomoyuki SASHIMA, Tokyo (JP); Yuma SAITO, Yokohama-shi (JP)

(21) Appl. No.: 18/849,524

(22) PCT Filed: Mar. 7, 2023
(86) PCT No.: PCT/JP2023/008475

§ 371 Date: Sep. 22, 2024

(30) Foreign Application Priority Data
Mar. 24, 2022 (JP) 2022-047890

(51) Int. Cl. G02B 13/00; G02B 7/02; G02B 15/14

(52) U.S. Cl. CPC G02B 13/009; G02B 7/025; G02B 13/0045; G02B 13/006; G02B 15/144511; G02B 15/144515

(57) ABSTRACT

A zoom optical system that is suitable for moving image capturing, has a small size and a light weight, and can obtain favorable optical performance, an optical apparatus, and a method for manufacturing the zoom optical system are provided.

A zoom optical system ZL included in an optical apparatus such as a camera 1 includes, sequentially from an object side, a first lens group G1 having negative refractive power, a second lens group G2 having positive refractive power, a third lens group G3, and a fourth lens group G4 having positive refractive power, an space between adjacent lens groups changes at zooming, with the first lens group G1 fixed relative to an image plane and the fourth lens group G4 moving along an optical axis, at least the second lens group G2 moves along the optical axis at focusing, and the zoom optical system ZL satisfies a condition expressed by a predetermined conditional expression.

### TECHNICAL FIELD

The present invention relates to a zoom optical system, an optical apparatus, and a method for manufacturing the zoom optical system.

### BACKGROUND ART

Conventionally, a zoom optical system that is applicable to moving image capturing has been disclosed (refer to Patent Literature 1, for example). However, further size and weight reduction and further improvement of optical performance are required.

### CITATION LIST

### Patent Literature

Patent Literature 1: Japanese Patent Laid-open No. 2019-120823

### SUMMARY OF INVENTION

A zoom optical system according to a first aspect of the present invention includes, sequentially from an object side, a first lens group having negative refractive power, a second lens group having positive refractive power, a third lens group, and a fourth lens group having positive refractive power, a space between adjacent lens groups changes at zooming, with the first lens group fixed relative to an image plane and the fourth lens group moving along an optical axis, at least the second lens group moves along the optical axis at focusing, and the zoom optical system satisfies a condition expressed by an expression below,

$$0.05 < ( - f 1 ) / f 2 < 1.5$$

$$0.1 < ft / Bft < 1.5$$

in the expressions,
f1: focal length of the first lens group,
f2: focal length of the second lens group,
ft: overall focal length of the zoom optical system in a telephoto end state, and
Bft: back focus of the zoom optical system in the telephoto end state.

A zoom optical system according to a second aspect of the present invention includes, sequentially from an object side, a first lens group having negative refractive power, a second lens group having positive refractive power, a third lens group, and a fourth lens group having positive refractive power, a space between adjacent lens groups changes at zooming, with the first lens group fixed relative to an image plane and the fourth lens group moving along an optical axis, at least the second lens group moves along the optical axis at focusing, and the zoom optical system satisfies a condition expressed by an expression below,

$$0. 010 < ( - f 1 ) / \vert f 3 \vert < 1.$$

$$0.1 < f 4 / f 2 < 1.2$$

in the expressions,
f1: focal length of the first lens group,
f2: focal length of the second lens group,
f3: focal length of the third lens group, and
f4: focal length of the fourth lens group.

A method for manufacturing the zoom optical system according to the first aspect of the present invention is a method for manufacturing a zoom optical system including, sequentially from an object side, a first lens group having negative refractive power, a second lens group having positive refractive power, a third lens group, and a fourth lens group having positive refractive power, the method including disposing the lens groups so that an space between adjacent lens groups changes at zooming, with the first lens group fixed relative to an image plane and the fourth lens group moving along an optical axis, disposing the lens groups so that at least the second lens group moves along the optical axis at focusing, and disposing the lens groups so that a condition expressed by an expression below is satisfied,

$$0. 50 < ( - f 1 ) / f 2 < 1.5$$

$$0.1 < ft / Bft < 1.5$$

in the expressions,
f1: focal length of the first lens group,
f2: focal length of the second lens group,
ft: overall focal length of the zoom optical system in a telephoto end state, and
Bft: back focus of the zoom optical system in the telephoto end state.

A method for manufacturing the zoom optical system according to the second aspect of the present invention is a method for manufacturing a zoom optical system including, sequentially from an object side, a first lens group having negative refractive power, a second lens group having positive refractive power, a third lens group, and a fourth lens group having positive refractive power, the method including disposing the lens groups so that an space between adjacent lens groups changes at zooming, with the first lens group fixed relative to an image plane and the fourth lens group moving along an optical axis, disposing the lens groups so that at least the second lens group moves along the optical axis at focusing, and disposing the lens groups so that a condition expressed by an expression below is satisfied,

$$0.01 < ( - f 1 ) / \vert f 3 \vert < 1.$$

$$0.1 < f 4 / f 2 < 1.2$$

in the expressions,
f1: focal length of the first lens group,
f2: focal length of the second lens group,
f3: focal length of the third lens group, and
f4: focal length of the fourth lens group.

### BRIEF DESCRIPTION OF DRAWINGS

FIG. 1 is a cross-sectional view showing a lens configuration of a zoom optical system according to a first example.

FIG. 2 shows a variety of aberration diagrams of the zoom optical system according to the first example; (a) shows a wide-angle end state and (b) shows a telephoto end state.

FIG. 3 is a cross-sectional view showing a lens configuration of a zoom optical system according to a second example.

FIG. 4 shows a variety of aberration diagrams of the zoom optical system according to the second example; (a) shows a wide-angle end state and (b) shows a telephoto end state.

FIG. 5 is a cross-sectional view showing a lens configuration of a zoom optical system according to a third example.

FIG. 6 shows a variety of aberration diagrams of the zoom optical system according to the third example; (a) shows a wide-angle end state and (b) shows a telephoto end state.

FIG. 7 is a cross-sectional view showing a lens configuration of a zoom optical system according to a fourth example.

FIG. 8 shows a variety of aberration diagrams of the zoom optical system according to the fourth example; (a) shows a wide-angle end state and (b) shows a telephoto end state.

FIG. 9 is a cross-sectional view of a camera on which an above-described zoom optical system is mounted.

FIG. 10 is a flowchart for description of a method for manufacturing the above-described zoom optical system.

### DESCRIPTION OF EMBODIMENTS

Preferable embodiments will be described below with reference to the drawings.

### First Embodiment

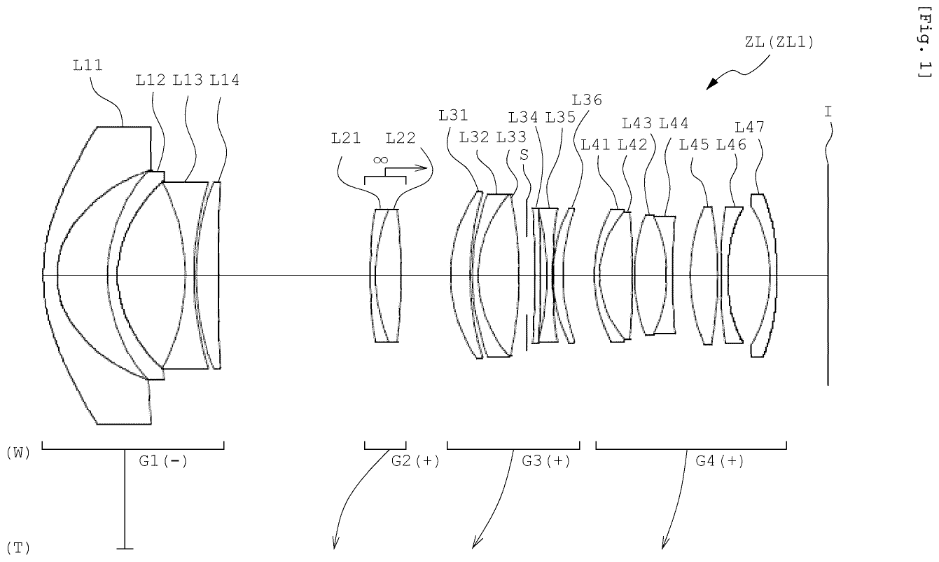

As shown in FIG. 1, a zoom optical system ZL according to a first embodiment includes, sequentially from an object side, a first lens group G1 having negative refractive power, a second lens group G2 having positive refractive power, a third lens group G3, and a fourth lens group G4 having positive refractive power. The space between adjacent lens groups changes at zooming, with the first lens group G1 fixed relative to an image plane and the fourth lens group G4 moving along an optical axis. At least the second lens group G2 moves along the optical axis at focusing. With this configuration, zooming and focusing are performed with lens groups other than the first lens group G1 having a large diameter and a heavy weight, and thus each lens group can be easily moved, which is preferable for image capturing of a moving image or the like.

Moreover, the zoom optical system ZL according to the first embodiment preferably satisfies Conditional Expression (1) shown below.

$$0.05 < ( - f 1 ) / f 2 < 1.5 \qquad ( 1 )$$

in the expression,
f1: focal length of the first lens group G1, and
f2: focal length of the second lens group G2.

Conditional Expression (1) defines the ratio of the focal length of the first lens group G1 to the focal length of the second lens group G2. By satisfying Conditional Expression (1), it is possible to obtain favorable optical performance while achieving size reduction of the zoom optical system ZL. When the upper limit value of Conditional Expression (1) is exceeded, the focal length of the second lens group G2 is short, and accordingly, spherical aberration, coma aberration, and field curvature that occur at the second lens group G2 are large and favorable optical performance is not obtained at zooming, and thus such a configuration is not preferable. Meanwhile, it is possible to secure the advantageous effect of the present embodiment more surely by setting the upper limit value of Conditional Expression (1) to 0.800. Further, in order to secure the advantageous effect of the present embodiment further more surely, it is preferable to set the upper limit value of Conditional Expression (1) to 0.650. Moreover, when the lower limit value of Conditional Expression (1) is exceeded, the focal length of the first lens group G1 is short, and accordingly, coma aberration and field curvature that occur at the first lens group G1 are large and favorable optical performance is not obtained at zooming, and thus such a configuration is not preferable. Meanwhile, it is possible to secure the advantageous effect of the present embodiment more surely by setting the lower limit value of Conditional Expression (1) to 0.100. Further, in order to secure the advantageous effect of the present embodiment further more surely, it is preferable to set the lower limit value of Conditional Expression (1) to 0.150.

Moreover, the zoom optical system ZL according to the first embodiment preferably satisfies Conditional Expression (2) shown below.

$$0.1 < ft / Bft < 1.5 \qquad ( 2 )$$

in the expression,
ft: overall focal length of the zoom optical system ZL at focusing on an infinite distance object in a telephoto end state, and
Bft: back focus (air-conversion length) of the zoom optical system ZL in the telephoto end state

Conditional Expression (2) defines the ratio of the overall focal length at focusing on an infinite distance object to the back focus of the zoom optical system ZL in the telephoto end state. By satisfying Conditional Expression (2), it is possible to obtain favorable optical performance while achieving size reduction of the zoom optical system ZL. Meanwhile, it is possible to secure the advantageous effect of the present embodiment more surely by setting the upper limit value of Conditional Expression (2) to 1.300. Further, in order to secure the advantageous effect of the present embodiment further more surely, it is preferable to set the upper limit value of Conditional Expression (2) to 1.100. Moreover, it is possible to secure the advantageous effect of the present embodiment more surely by the lower limit value of Conditional Expression (2) to 0.300. Further, in order to secure the advantageous effect of the present embodiment further more surely, it is preferable to set the lower limit value of Conditional Expression (2) to 0.600.

### Second Embodiment

As shown in FIG. 1, the zoom optical system ZL according to a second embodiment includes, sequentially from an object side, a first lens group G1 having negative refractive power, a second lens group G2 having positive refractive power, a third lens group G3, and a fourth lens group G4 having positive refractive power. The space between adjacent lens groups changes at zooming, with the first lens group G1 fixed relative to an image plane and the fourth lens group G4 moving along an optical axis. At least the second lens group G2 moves along the optical axis at focusing. With this configuration, zooming and focusing are performed with lens groups other than the first lens group G1 having a large diameter and a heavy weight, and thus each lens group can be easily moved, which is preferable for image capturing of a moving image or the like.

Moreover, the zoom optical system ZL according to the second embodiment preferably satisfies Conditional Expression (3) shown below.

$$0.01 < ( - f 1 ) / \vert f 3 \vert < 1. \qquad ( 3 )$$

in the expression,
f1: focal length of the first lens group G1, and
f3: focal length of the third lens group G3.

Conditional Expression (3) defines the ratio of the focal length of the first lens group G1 to the focal length of the third lens group G3. By satisfying Conditional Expression (3), it is possible to obtain favorable optical performance while achieving size reduction of the zoom optical system ZL. When the upper limit value of Conditional Expression (3) is exceeded, the focal length of the third lens group G3 is short, and accordingly, spherical aberration, coma aberration, and field curvature that occur at the third lens group G3 are large and favorable optical performance is not obtained at zooming, and thus such a configuration is not preferable. Meanwhile, it is possible to secure the advantageous effect of the present embodiment more surely by setting the upper limit value of Conditional Expression (3) to 0.500. Further, in order to secure the advantageous effect of the present embodiment further more surely, it is preferable to set the upper limit value of Conditional Expression (3) to 0.250. Moreover, when the lower limit value of Conditional Expression (3) is exceeded, the focal length of the first lens group G1 is short, and accordingly, coma aberration and field curvature that occur at the first lens group G1 are large and favorable optical performance is not obtained at zooming, and thus such a configuration is not preferable. Meanwhile, it is possible to secure the advantageous effect of the present embodiment more surely by the lower limit value of Conditional Expression (3) to 0.040. Further, in order to secure the advantageous effect of the present embodiment further more surely, it is preferable to set the lower limit value of Conditional Expression (3) to 0.070.

Moreover, the zoom optical system ZL according to the second embodiment preferably satisfies Conditional Expression (4) shown below.

$$0.1 < f 4 / f 2 < 1.2 \qquad ( 4 )$$

in the expression,
f2: focal length of the second lens group G2, and
f4: focal length of the fourth lens group G4.

Conditional Expression (4) defines the ratio of the focal length of the fourth lens group G4 to the focal length of the second lens group G2. By satisfying Conditional Expression (4), it is possible to obtain favorable optical performance while achieving size reduction of the zoom optical system ZL. When the upper limit value of Conditional Expression (4) is exceeded, the focal length of the second lens group G2 is short, and accordingly, spherical aberration, coma aberration, and field curvature that occur at the second lens group G2 are large and favorable optical performance is not obtained at zooming, and thus such a configuration is not preferable. Meanwhile, it is possible to secure the advantageous effect of the present embodiment more surely by setting the upper limit value of Conditional Expression (4) to 1.000. Further, in order to secure the advantageous effect of the present embodiment further more surely, it is preferable to set the upper limit value of Conditional Expression (4) to 0.950. Moreover, when the lower limit value of Conditional Expression (4) is exceeded, the focal length of the fourth lens group G4 is short, and accordingly, field curvature that occurs at the fourth lens group G4 is large and favorable optical performance is not obtained at zooming, and thus such a configuration is not preferable. Meanwhile, it is possible to secure the advantageous effect of the present embodiment more surely by the lower limit value of Conditional Expression (4) to 0.250. Further, in order to secure the advantageous effect of the present embodiment further more surely, it is preferable to set the lower limit value of Conditional Expression (4) to 0.350.

### First and Second Embodiments

Moreover, the zoom optical system ZL according to the first embodiment desirably satisfies Conditional Expression (3) described above. The advantageous effect and the like obtained by satisfying Conditional Expression (3) are as described above.

Moreover, the zoom optical system ZL according to the first embodiment desirably satisfies Conditional Expression (4) described above. The advantageous effect and the like obtained by satisfying Conditional Expression (4) are as described above.

Moreover, the zoom optical system ZL according to the first and second embodiments (hereinafter referred to as “the present embodiment”) preferably satisfies Conditional Expression (5) shown below.

$$0.01 < ( - f 1 ) / \vert f 3 \vert < 1. \qquad ( 5 )$$

in the expression,
f3: focal length of the third lens group G3, and
f4: focal length of the fourth lens group G4.

Conditional Expression (5) defines the ratio of the focal length of the fourth lens group G4 to the focal length of the third lens group G3. By satisfying Conditional Expression (5), it is possible to obtain favorable optical performance while achieving size reduction of the zoom optical system ZL. When the upper limit value of Conditional Expression (5) is exceeded, the focal length of the third lens group G3 is short, and accordingly, spherical aberration, coma aberration, and field curvature that occur at the third lens group G3 are large and favorable optical performance is not obtained at zooming, and thus such a configuration is not preferable. Meanwhile, it is possible to secure the advantageous effect of the present embodiment more surely by setting the upper limit value of Conditional Expression (5) to 0.800. Further, in order to secure the advantageous effect of the present embodiment further more surely, it is preferable to set the upper limit value of Conditional Expression (5) to 0.550. Moreover, when the lower limit value of Conditional Expression (5) is exceeded, the focal length of the fourth lens group G4 is short, and accordingly, field curvature that occurs at the fourth lens group G4 is large and favorable optical performance is not obtained at zooming, and thus such a configuration is not preferable. Meanwhile, it is possible to secure the advantageous effect of the present embodiment more surely by the lower limit value of Conditional Expression (5) to 0.070. Further, in order to secure the advantageous effect of the present embodiment further more surely, it is preferable to set the lower limit value of Conditional Expression (5) to 0.130.

Moreover, the zoom optical system ZL according to the present embodiment preferably satisfies Conditional Expression (6) shown below.

$$0. 150 < ( - f 1 ) / f 4 < 1.5 \qquad ( 6 )$$

in the expression,
f1: focal length of the first lens group G1, and
f4: focal length of the fourth lens group G4.

Conditional Expression (6) defines the ratio of the focal length of the first lens group G1 to the focal length of the fourth lens group G4. By satisfying Conditional Expression (6), it is possible to obtain favorable optical performance while achieving size reduction of the zoom optical system ZL. When the upper limit value of Conditional Expression (6) is exceeded, the focal length of the fourth lens group G4 is short, and accordingly, field curvature that occurs at the fourth lens group G4 is large and favorable optical performance is not obtained at zooming, and thus such a configuration is not preferable. Meanwhile, it is possible to secure the advantageous effect of the present embodiment more surely by setting the upper limit value of Conditional Expression (6) to 1.000. Further, in order to secure the advantageous effect of the present embodiment further more surely, it is preferable to set the upper limit value of Conditional Expression (6) to 0.700. Moreover, when the lower limit value of Conditional Expression (6) is exceeded, the focal length of the first lens group G1 is short, and accordingly, coma aberration and field curvature that occur at the first lens group G1 are large and favorable optical performance is not obtained at zooming, and thus such a configuration is not preferable. Meanwhile, it is possible to secure the advantageous effect of the present embodiment more surely by the lower limit value of Conditional Expression (6) to 0.300. Further, in order to secure the advantageous effect of the present embodiment further more surely, it is preferable to set the lower limit value of Conditional Expression (6) to 0.400.

Moreover, the zoom optical system ZL according to the present embodiment preferably satisfies Conditional Expression (7) shown below.

$$0. 0 \; 10 < f 2 / \vert f 3 \vert < 2. 0 \; 00 \qquad ( 7 )$$

in the expression,
f2: focal length of the second lens group G2, and
f3: focal length of the third lens group G3.

Conditional Expression (7) defines the ratio of the focal length of the second lens group G2 to the focal length of the third lens group G3. By satisfying Conditional Expression (7), it is possible to obtain favorable optical performance while achieving size reduction of the zoom optical system ZL. When the upper limit value of Conditional Expression (7) is exceeded, the focal length of the third lens group G3 is short, and accordingly, spherical aberration, coma aberration, and field curvature that occur at the third lens group G3 are large and favorable optical performance is not obtained at zooming, and thus such a configuration is not preferable. Meanwhile, it is possible to secure the advantageous effect of the present embodiment more surely by setting the upper limit value of Conditional Expression (7) to 1.500. Further, in order to secure the advantageous effect of the present embodiment further more surely, it is preferable to set the upper limit value of Conditional Expression (7) to 1.200. Moreover, when the lower limit value of Conditional Expression (7) is exceeded, the focal length of the second lens group G2 is short, and accordingly, spherical aberration, coma aberration, and field curvature that occur at the second lens group G2 are large and favorable optical performance is not obtained at zooming, and thus such a configuration is not preferable. Meanwhile, it is possible to secure the advantageous effect of the present embodiment more surely by the lower limit value of Conditional Expression (7) to 0.100. Further, in order to secure the advantageous effect of the present embodiment further more surely, it is preferable to set the lower limit value of Conditional Expression (7) to 0.200.

Moreover, the zoom optical system ZL according to the present embodiment preferably satisfies Conditional Expression (8) shown below.

$$0.01 < ft / TL < 1. \qquad ( 8 )$$

in the expression,
ft: overall focal length of the zoom optical system ZL at focusing on an infinite distance object in a telephoto end state, and
TL: optical total length (air-conversion length) of the zoom optical system ZL.

Conditional Expression (8) defines the ratio of the overall focal length at focusing on an infinite distance object to the optical total length of the zoom optical system ZL in the telephoto end state. By satisfying Conditional Expression (8), it is possible to obtain favorable optical performance while achieving size reduction of the zoom optical system ZL. Meanwhile, it is possible to secure the advantageous effect of the present embodiment more surely by setting the upper limit value of Conditional Expression (8) to 0.750. Further, in order to secure the advantageous effect of the present embodiment further more surely, it is preferable to set the upper limit value of Conditional Expression (8) to 0.380. Moreover, it is possible to secure the advantageous effect of the present embodiment more surely by the lower limit value of Conditional Expression (8) to 0.100. Further, in order to secure the advantageous effect of the present embodiment further more surely, it is preferable to set the lower limit value of Conditional Expression (8) to 0.150.

Moreover, the zoom optical system ZL according to the present embodiment preferably satisfies Conditional Expression (9) shown below.

$$0. 300 < fw / Bfw < 4.0 \; 00 \qquad ( 9 )$$

in the expression,
fw: overall focal length of the zoom optical system ZL at focusing on an infinite distance object in a wide-angle end state, and
Bfw: back focus (air-conversion length) of the zoom optical system ZL in the wide-angle end state.

Conditional Expression (9) defines the ratio of the overall focal length at focusing on an infinite distance object to the back focus of the zoom optical system ZL in the wide-angle end state. By satisfying Conditional Expression (9), it is possible to obtain favorable optical performance while achieving size reduction of the zoom optical system ZL. Meanwhile, it is possible to secure the advantageous effect of the present embodiment more surely by setting the upper limit value of Conditional Expression (9) to 3.000. Further, in order to secure the advantageous effect of the present embodiment further more surely, it is preferable to set the upper limit value of Conditional Expression (9) to 2.000. Moreover, it is possible to secure the advantageous effect of the present embodiment more surely by the lower limit value of Conditional Expression (9) to 0.500. Further, in order to secure the advantageous effect of the present embodiment further more surely, it is preferable to set the lower limit value of Conditional Expression (9) to 0.650.

Moreover, the zoom optical system ZL according to the present embodiment preferably satisfies Conditional Expression (10) shown below.

$$0.1 < f t / TLGt < 1. \qquad ( 10 )$$

in the expression,
ft: overall focal length of the zoom optical system ZL at focusing on an infinite distance object in the telephoto end state, and
TLGt: distance on the optical axis from a lens surface closest to the object side to a lens surface closest to the image plane side in the zoom optical system ZL in the telephoto end state.

Conditional Expression (10) defines the ratio of the overall focal length at focusing on an infinite distance object to the distance on the optical axis from the lens surface closest to the object side to the lens surface closest to the image plane side in the zoom optical system ZL in the telephoto end state. By satisfying Conditional Expression (10), it is possible to obtain favorable optical performance while achieving size reduction of the zoom optical system ZL. Meanwhile, it is possible to secure the advantageous effect of the present embodiment more surely by setting the upper limit value of Conditional Expression (10) to 0.800. Further, in order to secure the advantageous effect of the present embodiment further more surely, it is preferable to set the upper limit value of Conditional Expression (10) to 0.700. Moreover, it is possible to secure the advantageous effect of the present embodiment more surely by the lower limit value of Conditional Expression (10) to 0.250. Further, in order to secure the advantageous effect of the present embodiment further more surely, it is preferable to set the lower limit value of Conditional Expression (10) to 0.500.

Moreover, in the zoom optical system ZL according to the present embodiment, the third lens group G3 desirably has positive refractive power. With such a configuration, it is possible to obtain favorable optical performance while achieving size reduction of the zoom optical system ZL.

Moreover, in the zoom optical system ZL according to the present embodiment, the second lens group G2 is desirably constituted by one lens component. With such a configuration, it is possible to obtain favorable optical performance while achieving size reduction of the zoom optical system ZL.

Moreover, in the zoom optical system ZL according to the present embodiment, the second lens group G2 is desirably constituted by one positive lens and one negative lens. With such a configuration, it is possible to obtain favorable optical performance while achieving size reduction of the zoom optical system ZL.

Note that conditions and configurations described above each achieve an above-described effect, and not all configurations and conditions necessarily need to be satisfied but the above-described effect can be obtained with either conditions or configurations or with either combination of conditions or configurations.

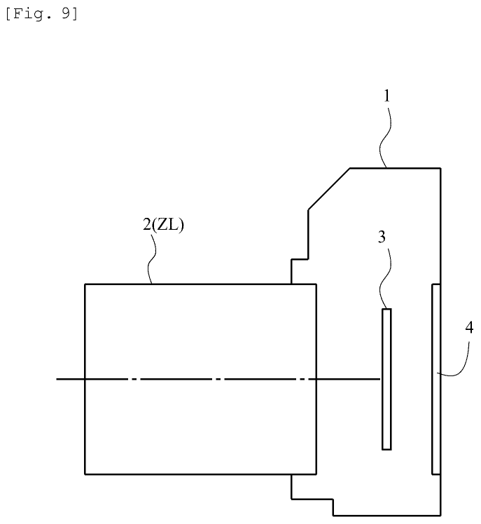

Subsequently, a camera that is an optical apparatus including the zoom optical system ZL according to the present embodiment will be described below with reference to FIG. 9. This camera 1 is what is called a mirrorless interchangeable lens camera including the zoom optical system ZL according to the present embodiment as an image pickup lens 2. In the camera 1, light from a non-shown object (subject) is condensed through the image pickup lens 2 and forms a subject image on the image surface of an image unit 3 through a non-shown optical low pass filter (OLPF). Then, the subject image is photoelectrically converted by a photoelectric conversion element (image sensor) provided in the image unit 3 and an image of the subject is generated. The image is displayed on an electronic view finder (EVF) 4 provided in the camera 1. Accordingly, a photographer can observe the subject through the EVF 4.

When a non-shown release button is pressed by the photographer, the image photoelectrically converted by the image unit 3 is stored in a non-shown memory. In this manner, the photographer can perform image capturing of the subject with the camera 1. Meanwhile, although the example of a mirrorless camera is described in the present embodiment, it is possible to achieve the same effects as those of the camera 1 described above when the zoom optical system ZL according to the present embodiment is mounted on a single-lens reflex camera that includes a quick return mirror in a camera body and with which a subject is observed through a finder optical system.

The contents described below are employable as appropriate to the extent that the optical performance is not compromised.

In the present embodiment, the zoom optical system ZL having a four-group configuration is shown, and such configurations, conditions, and the like are also applicable to any other group configuration such as a five-group configuration or a six-group configuration. Further, the zoom optical system ZL may instead have a configuration in which a lens or a lens group closest to the object side is added or a configuration in which a lens or a lens group closest to the image plane side is added. Specifically, such a configuration is a configuration in which a lens group having a position fixed relative to the image plane at zooming is added closest to the image plane side. A lens group means a part including at least one lens and separated by an air space that changes at zooming or focusing as long as no boundary is designated. A lens component means a single lens or a cemented lens obtained by cementing a plurality of lenses.

A focusing group may be a single lens group, a plurality of lens groups, or a partial lens group moved in the optical axis direction to focus on from an infinite distance object to a close distance object. In this case, the focusing group can also be used to perform autofocusing and is suitably driven by a motor for autofocusing (such as an ultrasonic wave motor). In particular, the focusing group is preferably at least one (or part) of the second lens group G2 and the third lens group G3, and any other lens preferably has a position fixed relative to the image plane at focusing.

An anti-vibration group may be a lens group or a partial lens group so moved with a displacement component in the direction perpendicular to the optical axis or rotated (swung) in an in-plane direction containing the optical axis to correct an image blur caused by a camera shake. In particular, the anti-vibration group is preferably at least part of the third lens group G3.

A lens surface may be so formed as to be a spherical surface, a flat surface, or an aspheric surface. In the case where a lens surface is a spherical or flat surface, the lens is readily processed, assembled, and adjusted, whereby degradation in the optical performance due to errors in the lens processing, assembly, and adjustment is preferably avoided. Further, even when an image plane is shifted, the amount of degradation in drawing performance is preferably small. In the case where the lens surface is an aspheric surface, the aspheric surface may be any of a ground aspheric surface, a glass molded aspheric surface that is a glass surface so molded in a die as to have an aspheric shape, and a composite aspheric surface that is a glass surface on which aspherically shaped resin is formed. The lens surface may instead be a diffractive surface, or the lenses may be any of a distributed index lens (GRIN lens) or a plastic lens.

An aperture stop S is preferably disposed in or near the third lens group G3. No member as an aperture stop may be provided, and the frame of a lens may serve as the aperture stop.

Further, each lens surface may be provided with an antireflection coating having high transmittance over a wide wavelength range to achieve good optical performance that reduces flare and ghost and achieves high contrast.

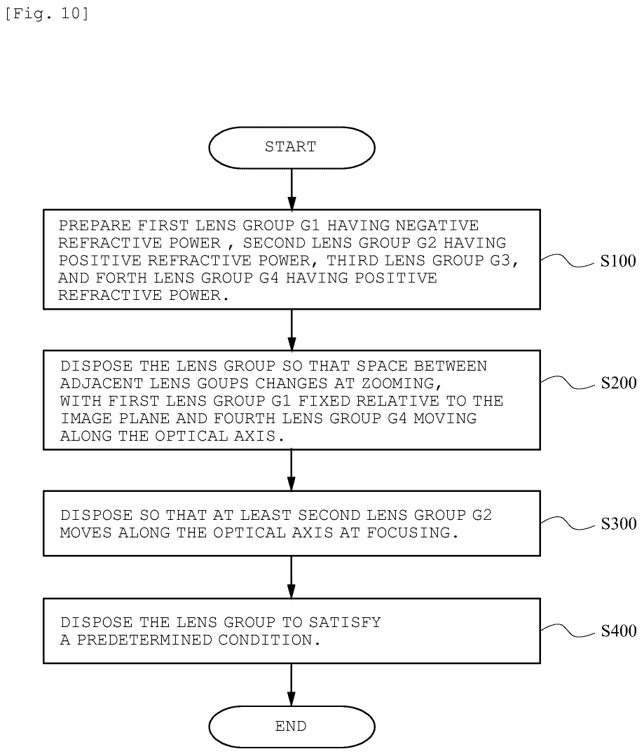

A method for manufacturing the zoom optical system ZL according to the present embodiment will be schematically described below with reference to FIG. 10. First, the first lens group G1 having negative refractive power, the second lens group G2 having positive refractive power, the third lens group G3, and the fourth lens group G4 having positive refractive power are prepared sequentially from the object side (step S100). Subsequently, the lens groups are disposed so that the space between adjacent lens groups changes at zooming, with the first lens group G1 fixed relative to the image plane and the fourth lens group G4 moving along the optical axis (step S200). The lens groups are disposed so that at least the second lens group G2 moves along the optical axis at focusing (step S300). Then, the lens groups are disposed so that a predetermined condition (for example, Conditional Expression (1), (2), (3), or (4) described above) is satisfied (step S400).

In this manner, a zoom optical system that is suitable for moving image capturing, has a small size and a light weight, and can obtain favorable optical performance, an optical apparatus, and a method for manufacturing the zoom optical system can be provided.

### EXAMPLES

Examples will be described below with reference to the drawings. Note that FIGS. 1, 3, 5, and 7 are cross-sectional views showing the configurations of zoom optical systems ZL (ZL1 to ZL4) according to the examples and the refractive index distribution thereof. In the cross-sectional views of the zoom optical systems ZL1 to ZL4, arrows show the moving directions of the lens groups G1 to G4 along the optical axis at zooming from the wide-angle end state (W) to the telephoto end state (T) and at focusing on from an infinite distance object (∞) to a close distance object.

In the examples, each aspheric surface is expressed by Expression (a) below, where y represents the height in a direction orthogonal to the optical axis, S (y) represents the distance (sag amount) on the optical axis from a tangent plane at the apex of the aspheric surface at the height y to the aspheric surface, r represents the radius of curvature (paraxial radius of curvature) of a reference spherical surface, K represents the conic constant, and An represents the n-th aspheric surface coefficient. Note that, in the examples below, “E-n” represents “×10⁻ⁿ”.

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} + A 12 \times {y}^{12} \qquad ( a )$$

Note that, in the examples, the second aspheric surface coefficient A2 is zero. In tables of the examples, the symbol “*” is attached on the right side of the surface number of an aspheric surface.

### First Example

FIG. 1 is a diagram showing the configuration of the zoom optical system ZL1 according to a first example. The zoom optical system ZL1 includes, sequentially from the object side, a first lens group G1 having negative refractive power, a second lens group G2 having positive refractive power, a third lens group G3 having positive refractive power, and a fourth lens group having positive refractive power.

The first lens group G1 includes, sequentially from the object side, an aspheric negative lens L11 in a negative meniscus lens shape formed with an aspheric lens surface on the object side and an aspheric lens surface on the image plane side and having a convex surface facing the object side, an aspheric negative lens L12 in a negative meniscus lens shape formed with an aspheric lens surface on the image plane side and having a convex surface facing the object side, a biconcave negative lens L13, and a positive meniscus lens L14 having a convex surface facing the object side.

The second lens group G2 includes a cemented positive lens formed by cementing a negative meniscus lens L21 having a convex surface facing the object side and a biconvex positive lens L22 sequentially from the object side.

The third lens group G3 includes, sequentially from the object side, a positive meniscus lens L31 having a convex surface facing the object side, a cemented positive lens formed by cementing a negative meniscus lens L32 having a convex surface facing the object side and a biconvex positive lens L33, a negative meniscus lens L34 having a concave surface facing the object side, a biconcave negative lens L35, and a positive meniscus lens L36 having a convex surface facing the object side.

The fourth lens group G4 includes, sequentially from the object side, a cemented positive lens formed by cementing a negative meniscus lens L41 having a convex surface facing the object side and a biconvex positive lens L42, a cemented negative lens formed by cementing a biconvex positive lens L43 and a biconcave negative lens L44, a biconvex positive lens L45, an aspheric negative lens L46 in a negative meniscus lens shape formed with a spheric lens surface on the image plane side and having a convex surface facing the object side, and an aspheric negative lens L47 in a negative meniscus lens shape formed with an aspheric lens surface on the image plane side and having a concave surface facing the object side.

In the zoom optical system ZL1, the space between adjacent lens groups changes at zooming from the wide-angle end state to the telephoto end state. Moreover, in the zoom optical system ZL1, at zooming, the first lens group G1 is fixed relative to an image plane I, and the second lens group G2, the third lens group G3, and the fourth lens group G4 move along the optical axis.

In the zoom optical system ZL1, the second lens group G2 moves to the image plane side at focusing on from an infinite distance object to a close distance object.

In the zoom optical system ZL1, the aperture stop S is disposed between the cemented positive lens formed by cementing the negative meniscus lens L32 and the biconvex positive lens L33 and the negative meniscus lens L34 in the third lens group G3 and moves along the optical axis together with the third lens group G3 at zooming.

Table 1 below shows values of specifications of the zoom optical system ZL1. In Table 1, the following specifications shown as overall specifications are defined as follows: f represents the overall focal length; Fno represents the F number; ω represents the half angle of view [°]; Y represents the maximum image height; TL represents the optical total length; and Bf represents values of the back focus at focusing on an infinite distance object in the wide-angle end state, an intermediate focal length state, and the telephoto end state. The optical total length TL represents the distance on the optical axis from the lens surface (first surface) closest to the object side to the image plane I. The back focus Bf represents the distance on the optical axis from the lens surface (thirty-fifth surface) closest to the image side to the image plane I. Note that the values of the optical total length TL and the back focus Bf are air-conversion lengths. In lens data, a first field m shows the sequence of lens surfaces (surface numbers) counted from the object side in a direction in which a ray travels. A second field r shows the radius of curvature of each lens surface. A third field d shows the distance (inter-surface distance) on the optical axis from each optical surface to the next optical surface. A fourth field nd and a fifth field νd show the refractive index and the Abbe number at the d line (λ=587.6 nm). A radius of curvature of ∞ represents a flat surface, and the refractive index of air, which is 1.00000, is omitted. The lens group focal length shows the surface number of the first surface and the focal length of each lens group.

The unit of each of the focal length f, the radius of curvature r, the inter-surface distance d, and other lengths shown in all the variety of specifications below is typically “mm”, but not limited to this, because an optical system provides the same optical performance even when the optical system is proportionally enlarged or reduced. The above description of symbols and specification tables applies to subsequent examples as well.

TABLE 1
First example
[Overall specifications]

| | Wide-angle | Intermediate | Telephoto |
|---|---|---|---|
| | end | focal length | end |
| f | =16.375 | ~24.000 | ~34.000 |
| Fno | =2.910 | ~2.910 | ~2.910 |
| ω[°] | =53.330 | ~42.239 | ~32.570 |
| Y | =20.397 | ~21.055 | ~21.599 |
| TL(air-conversion | =159.455 | ~159.455 | ~159.455 |
| length) | | | |
| Bf(air-conversion | =10.355 | ~22.514 | ~35.756 |
| length) | | | |

[Lens data]

| m | r | d | nd | νd | |
|---|---|---|---|---|---|
| Object plane | ∞ | D0 | | | |
| 1* | 35.0582 | 2.800 | 1.82098 | 42.50 | |
| 2* | 16.7377 | 10.337 | | | |
| 3 | 31.7067 | 2.000 | 1.82098 | 42.50 | |
| 4* | 21.6441 | 13.766 | | | |
| 5 | −40.1091 | 1.700 | 1.45600 | 91.37 | |
| 6 | 60.9680 | 0.541 | | | |
| 7 | 53.2492 | 4.453 | 2.00069 | 25.46 | |
| 8 | 485.8307 | D8 | | | |
| 9 | 88.0588 | 1.100 | 1.96300 | 24.11 | |
| 10 | 35.4164 | 5.224 | 1.67270 | 32.18 | |
| 11 | −110.5143 | D11 | | | |
| 12 | 29.3371 | 3.943 | 1.81666 | 29.30 | |
| 13 | 56.1980 | 0.468 | | | |
| 14 | 44.5698 | 1.232 | 1.84666 | 23.80 | |
| 15 | 24.6119 | 8.231 | 1.48749 | 70.32 | |
| 16 | −77.0710 | 1.416 | | | |
| 17 | ∞ | 1.853 | | | Aperture |
| | | | | | stop S |
| 18 | −229.7187 | 1.100 | 1.95375 | 32.33 | |
| 19 | −284.2053 | 1.377 | | | |
| 20 | −51.4494 | 1.100 | 1.95375 | 32.33 | |
| 21 | 95.9749 | 0.100 | | | |
| 22 | 30.9572 | 2.006 | 1.92286 | 20.88 | |
| 23 | 38.9406 | D23 | | | |
| 24 | 28.4971 | 1.100 | 1.95375 | 32.33 | |
| 25 | 19.4010 | 6.575 | 1.49782 | 82.57 | |
| 26 | −173.7622 | 0.401 | | | |
| 27 | 33.6267 | 6.625 | 1.49782 | 82.57 | |
| 28 | −28.3420 | 1.200 | 1.95375 | 32.33 | |
| 29 | 149.7072 | 3.576 | | | |
| 30 | 36.7805 | 5.550 | 1.80809 | 22.74 | |
| 31 | −77.2223 | 0.608 | | | |
| 32 | 97.7931 | 1.512 | 1.85108 | 40.12 | |
| 33* | 44.1538 | 8.527 | | | |
| 34 | −27.8483 | 1.400 | 1.82098 | 42.50 | |
| 35* | −59.3344 | Bf | | | |
| Image plane | ∞ | | | | |

[Focal length of lens groups]

| Lens group | First surface | Focal length |
|---|---|---|
| First lens group G1 | 1 | −24.581 |
| Second lens group G2 | 9 | 113.817 |
| Third lens group G3 | 12 | 120.097 |
| Fourth lens group G4 | 24 | 50.673 |

In the zoom optical system ZL1, the first surface, the second surface, the fourth surface, the thirty-third surface, and the thirty-fifth surface are aspheric surfaces. Table 2 below shows aspheric surface data, in other words, the values of the conic constant K and the aspheric surface constants A4 to A12 for the surface number.

TABLE 2
[Aspheric surface data]
First surface

| | | |
|---|---|---|
| K = 1 | A6 = −1.78487E−08 | A8 = 2.04398E−11 |
| A4 = −1.18404E−06 | A12 = −1.60620E−19 | |
| A10 = −9.10242E−15 | | |

Second surface

| | | |
|---|---|---|
| K = 1 | | |
| A4 = 2.17668E−05 | A6 = −1.32250E−08 | A8 = 7.55812E−11 |
| A10 = −3.29409E−13 | A12 = 5.66430E−16 | |

Fourth surface

| | | |
|---|---|---|
| K = 1 | | |
| A4 = −8.57708E−06 | A6 = −1.43980E−08 | A8 = −1.85528E−12 |
| A10 = 5.78174E−14 | A12 = −3.00240E−16 | |

Thirty-third surface

| | | |
|---|---|---|
| K = 1 | | |
| A4 = 1.80937E−05 | A6 = 4.76381E−08 | A8 = −2.53185E−10 |
| A10 = 2.50614E−12 | A12 = −3.69680E−15 | |

Thirty-fifth surface

| | | |
|---|---|---|
| K = 1 | | |
| A4 = 1.19645E−06 | A6 = −3.91842E−08 | A8 = 3.08087E−10 |
| A10 = −1.89993E−12 | A12 = 3.16740E−15 | |

In the zoom optical system ZL1, an on-axis air space D8 between the first lens group G1 and the second lens group G2, an on-axis air space D11 between the second lens group G2 and the third lens group G3, an on-axis air space D23 between the third lens group G3 and the fourth lens group G4, and the back focus Bf change at zooming and focusing. Table 3 below shows variable spaces in the wide-angle end state, the intermediate focal length state, and the telephoto end state at focusing on an infinite distance object and at focusing on a close distance object. Note that DO represents the distance from the lens surface (first surface) closest to the object side in the zoom optical system ZL1 to the object, f represents the focal length, and B represents the image pickup magnification. This description applies to subsequent examples as well.

TABLE 3
[Variable space data]

| | Infinity | | | Close distance object | | |
|---|---|---|---|---|---|---|
| | Wide- | | | Wide- | | |
| | angle | Inter- | Telephoto | angle | Inter- | Telephoto |
| | end | mediate | end | end | mediate | end |
| f | 16.375 | 24.000 | 34.000 | — | — | — |
| β | — | — | — | −0.033 | −0.033 | −0.033 |
| D0 | ∞ | ∞ | ∞ | 461.130 | 691.430 | 992.394 |
| D8 | 30.850 | 10.327 | 1.500 | 32.194 | 11.408 | 2.351 |
| D11 | 10.026 | 22.536 | 18.877 | 8.682 | 21.455 | 18.026 |
| D23 | 6.402 | 2.255 | 1.500 | 6.402 | 2.255 | 1.500 |
| Bf | 10.355 | 22.514 | 35.756 | 10.355 | 22.514 | 35.756 |

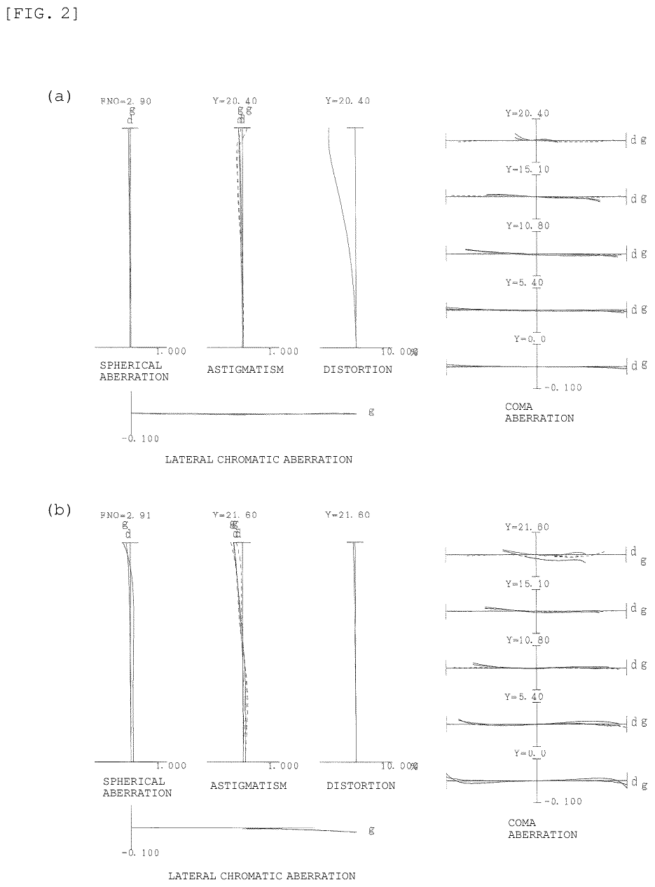

FIG. 2 shows a spherical aberration diagram, an astigmatism diagram, a distortion diagram, a lateral chromatic aberration diagram, and a coma aberration diagram of the zoom optical system ZL1 at focusing on an infinite distance object in the wide-angle end state and the telephoto end state. In each aberration diagram, FNO represents the F number, and Y represents the image height. Note that the spherical aberration diagram shows the value of the F number corresponding to the maximum diameter, the astigmatism diagram and the distortion diagram each show the maximum value of the image height, and the coma aberration diagram shows the value of each image height. In addition, reference character d represents the d-line (λ=587.6 nm), and reference character g represents the g-line (λ=435.8 nm). In the astigmatism diagram, the solid line represents the sagittal image plane, and the dashed line represents the meridional image plane. Further, in the aberration diagrams in the following examples, the same reference characters as those in the present example are used. The aberration diagrams show that the zoom optical system ZL1 allows favorable correction of the variety of aberrations and has excellent imaging performance.

### Second Example

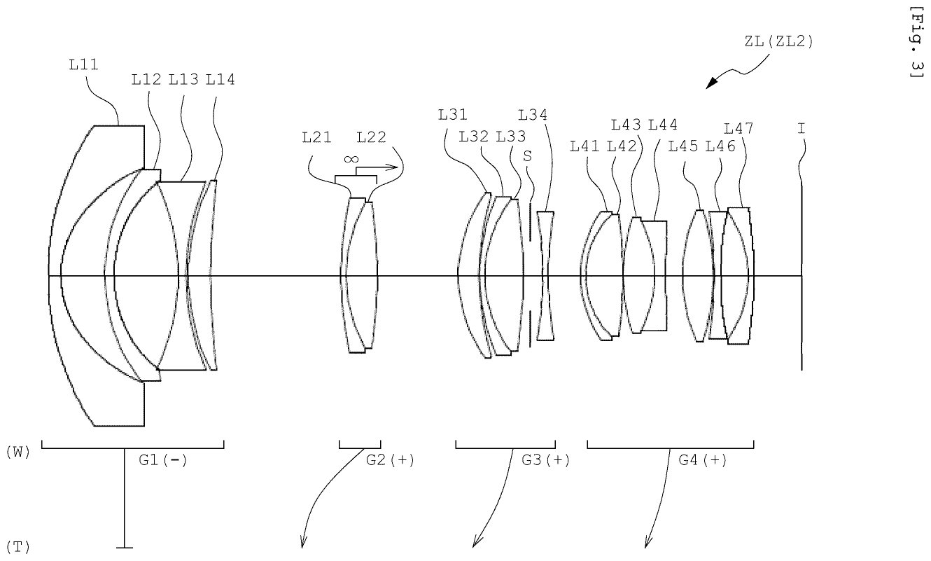

FIG. 3 is a diagram showing the configuration of a zoom optical system ZL2 according to a second example. The zoom optical system ZL2 includes, sequentially from the object side, a first lens group G1 having negative refractive power, a second lens group G2 having positive refractive power, a third lens group G3 having positive refractive power, and a fourth lens group having positive refractive power.

The first lens group G1 includes, sequentially from the object side, an aspheric negative lens L11 in a negative meniscus lens shape formed with an aspheric lens surface on the object side and an aspheric lens surface on the image plane side and having a convex surface facing the object side, an aspheric negative lens L12 in a negative meniscus lens shape formed with an aspheric lens surface on the image plane side and having a convex surface facing the object side, a biconcave negative lens L13, and a positive meniscus lens L14 having a convex surface facing the object side.

The second lens group G2 includes a cemented positive lens formed by cementing a negative meniscus lens L21 having a convex surface facing the object side and a biconvex positive lens L22 sequentially from the object side.

The third lens group G3 includes, sequentially from the object side, a positive meniscus lens L31 having a convex surface facing the object side, a cemented positive lens formed by cementing a negative meniscus lens L32 having a convex surface facing the object side and a biconvex positive lens L33, and a biconcave negative lens L34.

The fourth lens group G4 includes, sequentially from the object side, a cemented positive lens formed by cementing a negative meniscus lens L41 having a convex surface facing the object side and a biconvex positive lens L42, a cemented negative lens formed by cementing a biconvex positive lens L43 and a biconcave negative lens L44, a biconvex positive lens L45, an aspheric negative lens L46 in a biconcave negative lens shape formed with an aspheric lens surface on the image plane side, and an aspheric negative lens L47 in a negative meniscus lens shape formed with an aspheric lens surface on the image plane side and having a concave surface facing the object side.

In the zoom optical system ZL2, the space between adjacent lens groups changes at zooming from the wide-angle end state to the telephoto end state. In the zoom optical system ZL2, at zooming, the first lens group G1 is fixed relative to an image plane I, and the second lens group G2, the third lens group G3, and the fourth lens group G4 move along the optical axis.

In the zoom optical system ZL2, the second lens group G2 moves to the image plane side at focusing on from an infinite distance object to a close distance object.

In the zoom optical system ZL2, an aperture stop S is disposed between the cemented positive lens formed by cementing the negative meniscus lens L32 and the biconvex positive lens L33 and the biconcave negative lens L34 in the third lens group G3 and moves along the optical axis together with the third lens group G3 at zooming.

Table 4 below shows values of specifications of the zoom optical system ZL2.

TABLE 4
Second example
[Overall specifications]

| | Wide-angle | Intermediate | Telephoto |
|---|---|---|---|
| | end | focal length | end |
| f | =16.500 | ~24.000 | ~34.000 |
| Fno | =2.910 | ~2.910 | ~2.910 |
| ω[°] | =53.244 | ~42.298 | ~32.588 |
| Y | =20.529 | ~21.114 | ~21.632 |
| TL(air-conversion | =164.455 | ~164.455 | ~164.455 |
| length) | | | |
| Bf(air-conversion length) | =10.355 | ~21.907 | ~34.932 |

[Lens data]

| m | r | d | nd | νd | |
|---|---|---|---|---|---|
| Object plane | ∞ | D0 | | | |
| 1* | 67.9718 | 2.800 | 1.82098 | 42.50 | |
| 2* | 21.3995 | 9.567 | | | |
| 3 | 37.6575 | 2.000 | 1.82098 | 42.50 | |
| 4* | 27.3158 | 13.974 | | | |
| 5 | −47.1653 | 1.700 | 1.45600 | 91.37 | |
| 6 | 50.0315 | 0.571 | | | |
| 7 | 46.3866 | 4.818 | 2.00069 | 25.46 | |
| 8 | 157.7521 | D8 | | | |
| 9 | 75.2773 | 1.100 | 1.96300 | 24.11 | |
| 10 | 32.6428 | 6.697 | 1.67270 | 32.18 | |
| 11 | −109.8274 | D11 | | | |
| 12 | 29.9845 | 4.494 | 1.81666 | 29.30 | |
| 13 | 57.3435 | 0.100 | | | |
| 14 | 41.9240 | 1.200 | 1.84666 | 23.80 | |
| 15 | 27.0265 | 8.346 | 1.48749 | | |
| 16 | −109.6222 | 1.545 | | | |
| 17 | ∞ | 2.766 | | | Aperture |
| | | | | | stop S |
| 18 | −72.0021 | 1.100 | 1.95375 | 32.33 | |
| 19 | 74.7453 | D19 | | | |
| 20 | 24.4218 | 1.100 | 1.95375 | 32.33 | |
| 21 | 18.4764 | 8.090 | 1.49782 | 82.57 | |
| 22 | −102.1447 | 0.100 | | | |
| 23 | 40.6595 | 6.855 | 1.49782 | 82.57 | |
| 24 | −25.2216 | 2.393 | 1.95375 | 32.33 | |
| 25 | 239.9117 | 3.670 | | | |
| 26 | 34.1200 | 6.761 | 1.80809 | 22.74 | |
| 27 | −45.7105 | 0.136 | | | |
| 28 | −91.2255 | 1.400 | 1.85108 | 40.12 | |
| 29* | 82.4416 | 6.029 | | | |
| 30 | −23.6589 | 1.400 | 1.82098 | 42.50 | |
| 31* | −63.9793 | Bf | | | |
| Image plane | ∞ | | | | |

[Focal length of lens groups]

| Lens group | First surface | Focal length |
|---|---|---|
| First lens group G1 | 1 | −24.240 |
| Second lens group G2 | 9 | 100.531 |
| Third lens group G3 | 12 | 156.969 |
| Fourth lens group G4 | 20 | 47.722 |

In the zoom optical system ZL2, the first surface, the second surface, the fourth surface, the twenty-ninth surface, and the thirty-first surface are aspheric surfaces. Table 5 below shows aspheric surface data, in other words, the values of the conic constant K and the aspheric surface constants A4 to A12 for the surface number.

TABLE 5
[Aspheric surface data]
First surface

| | | |
|---|---|---|
| K = 1 | | |
| A4 = 8.17319E−06 | A6 = −1.88149E−08 | A8 = 1.87871E−11 |
| A10 = −7.74503E−15 | A12 = 1.03020E−18 | |

Second surface

| | | |
|---|---|---|
| K = 1 | | |
| A4 = 1.63234E−05 | A6 = 2.32356E−09 | A8 = −2.20036E−11 |
| A10 = −6.34872E−14 | A12 = 1.82740E−16 | |

Fourth surface

| | | |
|---|---|---|
| K = 1 | | |
| A4 = 2.20421E−06 | A6 = −1.28194E−08 | A8 = 6.50777E−11 |
| A10 = −8.76509E−14 | A12 = 4.81690E−17 | |

Twenty-nineth surface

| | | |
|---|---|---|
| K = 1 | | |
| A4 = 1.17598E−05 | A6 = −1.00073E−08 | A8 = 2.62820E−11 |
| A10 = 8.49715E−13 | A12 = −3.69680E−15 | |

Thirty-first surface

| | | |
|---|---|---|
| K = 1 | | |
| A4 = 6.90553E−06 | A6 = 2.29334E−08 | A8 = −1.90581E−11 |
| A10 = −7.45460E−13 | A12 = 3.16740E−15 | |

In the zoom optical system ZL2, an on-axis air space D8 between the first lens group G1 and the second lens group G2, an on-axis air space D11 between the second lens group G2 and the third lens group G3, an on-axis air space D19 between the third lens group G3 and the fourth lens group G4, and the back focus Bf change at zooming and focusing. Table 6 below shows variable spaces in the wide-angle end state, the intermediate focal length state, and the telephoto end state at focusing on an infinite distance object and at focusing on a close distance object.

TABLE 6
[Variable space data]

| | Infinity | | | Close distance object | | |
|---|---|---|---|---|---|---|
| | Wide- | | | Wide- | | |
| | angle | Inter- | Telephoto | angle | Inter- | Telephoto |
| | end | mediate | end | end | mediate | end |
| f | 16.500 | 24.000 | 34.000 | — | — | — |
| β | — | — | — | −0.033 | −0.033 | −0.033 |
| D0 | ∞ | ∞ | ∞ | 465.588 | 692.044 | 993.025 |
| D8 | 28.510 | 10.140 | 1.500 | 29.763 | 11.126 | 2.270 |
| D11 | 17.764 | 29.157 | 25.812 | 16.511 | 28.172 | 25.042 |
| D19 | 7.115 | 2.540 | 1.500 | 7.115 | 2.540 | 1.500 |
| Bf | 10.355 | 21.907 | 34.932 | 10.355 | 21.907 | 34.932 |

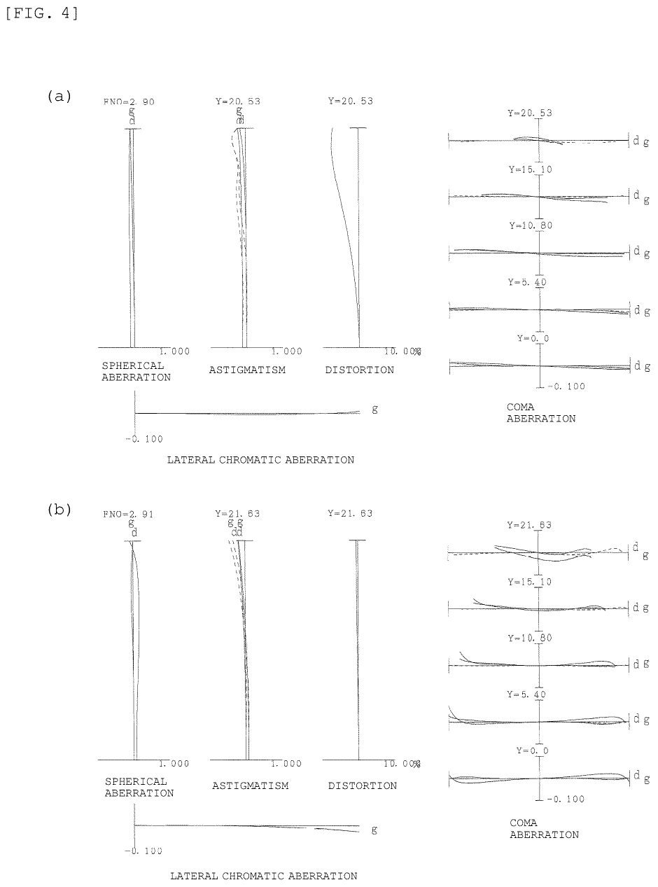

FIG. 4 shows a spherical aberration diagram, an astigmatism diagram, a distortion diagram, a lateral chromatic aberration diagram, and a coma aberration diagram of the zoom optical system ZL2 at focusing on an infinite distance object in the wide-angle end state and the telephoto end state. The aberration diagrams show that the zoom optical system ZL2 allows favorable correction of the variety of aberrations and has excellent imaging performance.

### Third Example

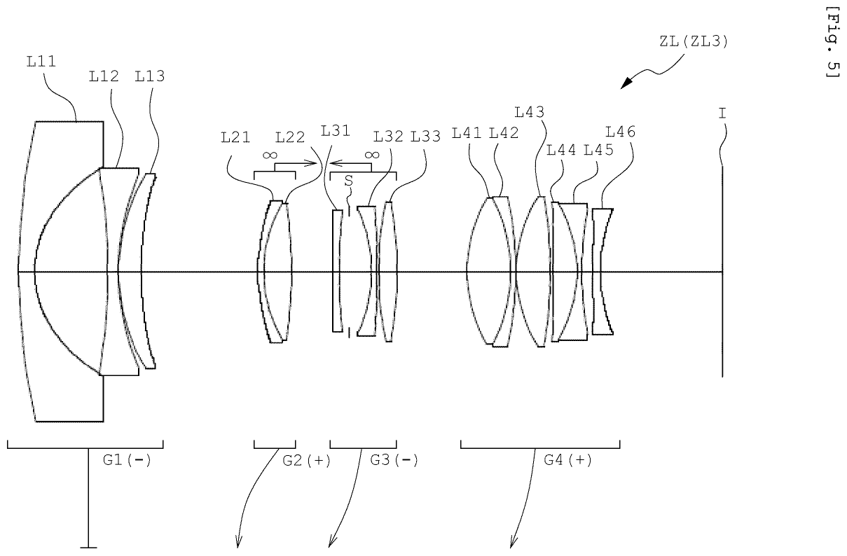

FIG. 5 is a diagram showing the configuration of a zoom optical system ZL3 according to a third example. The zoom optical system ZL3 includes, sequentially from the object side, a first lens group G1 having negative refractive power, a second lens group G2 having positive refractive power, a third lens group G3 having negative refractive power, and a fourth lens group having positive refractive power.

The first lens group G1 includes, sequentially from the object side, an aspheric negative lens L11 in a negative meniscus lens shape formed with an aspheric lens surface on the image plane side and having a convex surface facing the object side, a biconcave negative lens L12, and an aspheric positive lens L13 in a positive meniscus lens shape formed with an aspheric lens surface on the image plane side and having a convex surface facing the object side.

The second lens group G2 includes a cemented positive lens formed by cementing an aspheric negative lens L21 in a negative meniscus lens shape formed with an aspheric lens surface on the object side and having a convex surface facing the object side and a biconvex positive lens L22 sequentially from the object side.

The third lens group G3 includes, sequentially from the object side, a negative meniscus lens L31 having a convex surface facing the object side, a negative meniscus lens L32 having a concave surface facing the object side, and a biconvex positive lens L33.

The fourth lens group G4 includes, sequentially from the object side, a cemented positive lens formed by cementing a biconvex positive lens L41 and a negative meniscus lens L42 having a concave surface facing the object side, a biconvex positive lens L43, a cemented negative lens formed by cementing a positive meniscus lens L44 having a concave surface facing the object side and a biconcave negative lens L45, and an aspheric negative lens L46 in a negative meniscus lens shape formed with an aspheric lens surface on the object side and an aspheric lens surface on the image plane side and having a convex surface facing the object side.

In the zoom optical system ZL3, the space between adjacent lens groups changes at zooming from the wide-angle end state to the telephoto end state. Moreover, in the zoom optical system ZL3, at zooming, the first lens group G1 is fixed relative to an image plane I, and the second lens group G2, the third lens group G3, and the fourth lens group G4 move along the optical axis.

In the zoom optical system ZL3, at focusing on from an infinite distance object to a close distance object, the second lens group G2 moves to the image plane side and the third lens group G3 moves to the object side.

In the zoom optical system ZL3, an aperture stop S is disposed between the negative meniscus lens L31 and the negative meniscus lens L32 in the third lens group G3 and moves along the optical axis together with the third lens group G3 at zooming and focusing.

Table 7 below shows values of specifications of the zoom optical system ZL3.

TABLE 7
Third example
[Overall specifications]

| | Wide-angle | Intermediate | Telephoto |
|---|---|---|---|
| | end | focal length | end |
| f | =18.500 | ~28.001 | ~48.473 |
| Fno | =1.974 | ~2.508 | ~4.120 |
| ω[°] | =50.726 | ~37.607 | ~23.903 |
| Y | =20.799 | ~21.700 | ~21.700 |
| TL(air-conversion | =139.484 | ~139.484 | ~139.484 |
| length) | | | |
| Bf(air-conversion length) | =24.098 | ~35.551 | ~58.886 |

[Lens data]

| m | r | d | nd | νd | |
|---|---|---|---|---|---|
| Object plane | ∞ | D0 | | | |
| 1 | 138.6428 | 3.000 | 1.54449 | 56.33 | |
| 2* | 19.3464 | 14.626 | | | |
| 3 | −116.1278 | 2.000 | 1.77250 | 49.46 | |
| 4 | 46.8544 | 0.100 | | | |
| 5 | 37.5275 | 4.434 | 1.94594 | 17.98 | |
| 6* | 66.5532 | D6 | | | |
| 7* | 39.5868 | 1.100 | 1.82115 | 24.06 | |
| 8 | 27.4793 | 5.497 | 1.64000 | 60.20 | |
| 9 | −91.3357 | D9 | | | |
| 10 | 1660.8371 | 1.200 | 1.80625 | 40.91 | |
| 11 | 115.4552 | 2.174 | | | |
| 12 | ∞ | 4.192 | | | Aperture |
| | | | | | stop S |
| 13 | −29.8167 | 1.247 | 1.76385 | 48.49 | |
| 14 | −140.2473 | 0.200 | | | |
| 15 | 66.1759 | 3.651 | 1.68893 | 31.16 | |
| 16 | −80.2468 | D16 | | | |
| 17 | 29.0393 | 8.658 | 1.59282 | 68.62 | |
| 18 | −31.0177 | 1.000 | 2.00330 | 28.27 | |
| 19 | −69.5190 | 0.100 | | | |
| 20 | 27.7549 | 6.701 | 1.55032 | 75.49 | |
| 21 | −89.6746 | 0.636 | | | |
| 22 | −347.6865 | 4.652 | 2.00272 | 19.32 | |
| 23 | −26.8868 | 1.000 | 2.00330 | 28.27 | |
| 24 | 65.0833 | 2.088 | | | |
| 25* | 61.7639 | 1.600 | 1.95150 | 29.83 | |
| 26* | 28.1094 | Bf | | | |
| Image plane | ∞ | | | | |

[Focal length of lens groups]

| Lens group | First surface | Focal length |
|---|---|---|
| First lens group G1 | 1 | −24.310 |
| Second lens group G2 | 7 | 48.034 |
| Third lens group G3 | 10 | −148.331 |
| Fourth lens group G4 | 17 | 41.035 |

In the zoom optical system ZL3, the second surface, the sixth surface, the seventh surface, the twenty-fifth surface, and the twenty-sixth surface are aspheric surfaces. Table 8 below shows aspheric surface data, in other words, the values of the conic constant K and the aspheric surface constants A4 to A12 for the surface number.

TABLE 8
[Aspheric surface data]
Second surface

| | | |
|---|---|---|
| K = 1 | | |
| A4 = 9.51553E−06 | A6 = 1.21754E−08 | A8 = −5.92398E−11 |
| A10 = 2.46358E−13 | A12 = −3.27160E−16 | |

Sixth surface

| | | |
|---|---|---|
| K = 1 | | |
| A4 = 1.51701E−07 | A6 = 3.95534E−09 | A8 = −2.06177E−11 |
| A10 = 7.48105E−14 | A12 = −7.38860E−17 | |

Seventh surface

| | | |
|---|---|---|
| K = 1 | | |
| A4 = −2.10374E−06 | A6 = −1.68231E−09 | A8 = 2.88731E−13 |
| A10 = 3.11082E−14 | A12 = −7.40790E−17 | |

Twenty-fifth surface

| | | |
|---|---|---|
| K = 1 | | |
| A4 = −9.20691E−05 | A6 = 3.33506E−07 | A8 = −3.76359E−10 |
| A10 = −3.03908E−12 | A12 = 9.58650E−15 | |

Twenty-sixth surface

| | | |
|---|---|---|
| K = 1 | | |
| A4 = −5.96955E−05 | A6 = 4.23747E−07 | A8 = −3.95963E−10 |
| A10 = −3.68864E−12 | A12 = 1.18830E−14 | |

In the zoom optical system ZL3, an on-axis air space D6 between the first lens group G1 and the second lens group G2, an on-axis air space D9 between the second lens group G2 and the third lens group G3, an on-axis air space D16 between the third lens group G3 and the fourth lens group G4, and the back focus Bf change at zooming and focusing. Table 9 below shows variable spaces in the wide-angle end state, the intermediate focal length state, and the telephoto end state at focusing on an infinite distance object and at focusing on a close distance object.

TABLE 9
[Variable space data]

| | Infinity | | | Close distance object | | |
|---|---|---|---|---|---|---|
| | Wide- | | | Wide- | | |
| | angle | Inter- | Telephoto | angle | Inter- | Telephoto |
| | end | mediate | end | end | mediate | end |
| f | 18.500 | 28.001 | 48.473 | — | — | — |
| β | — | — | — | −0.033 | −0.033 | −0.033 |
| D0 | ∞ | ∞ | ∞ | 516.893 | 808.024 | 1424.067 |
| D6 | 23.309 | 10.765 | 1.300 | 24.476 | 11.449 | 1.677 |
| D9 | 8.266 | 18.006 | 7.942 | 6.281 | 17.151 | 7.302 |
| D16 | 13.956 | 5.306 | 1.500 | 14.773 | 5.477 | 1.763 |
| Bf | 24.098 | 35.551 | 58.886 | 24.098 | 35.551 | 58.886 |

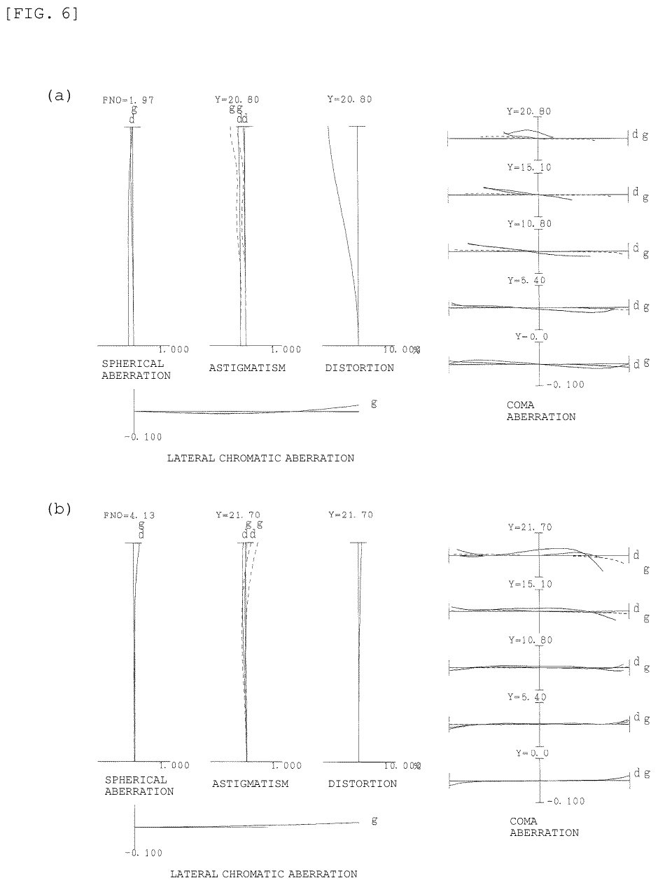

FIG. 6 shows a spherical aberration diagram, an astigmatism diagram, a distortion diagram, a lateral chromatic aberration diagram, and a coma aberration diagram of the zoom optical system ZL3 at focusing on an infinite distance object in the wide-angle end state and the telephoto end state. The aberration diagrams show that the zoom optical system ZL3 allows favorable correction of the variety of aberrations and has excellent imaging performance.

### Fourth Example

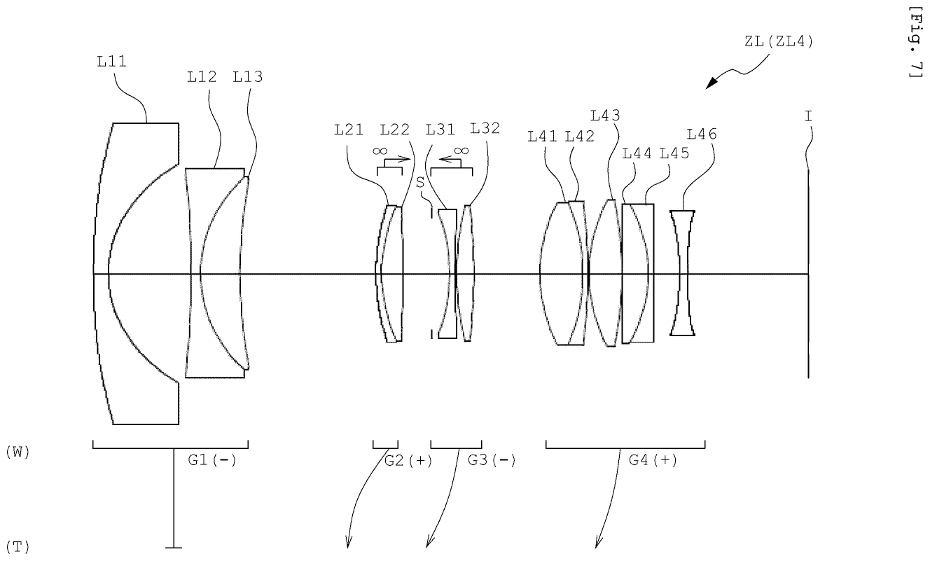

FIG. 7 is a diagram showing the configuration of a zoom optical system ZL4 according to a fourth example. The zoom optical system ZL4 includes, sequentially from the object side, a first lens group G1 having negative refractive power, a second lens group G2 having positive refractive power, a third lens group G3 having negative refractive power, and a fourth lens group having positive refractive power.

The first lens group G1 includes, sequentially from the object side, an aspheric negative lens L11 in a negative meniscus lens shape formed with an aspheric lens surface on the object side and an aspheric lens surface on the image plane side and having a convex surface facing the object side, and a cemented negative lens formed by cementing a biconcave negative lens L12 and a positive meniscus lens L13.

The second lens group G2 includes a cemented positive lens formed by cementing an aspheric negative lens L21 in a negative meniscus lens shape formed with an aspheric lens surface on the object side and having a convex surface facing the object side and a biconvex positive lens L22 sequentially from the object side.

The third lens group G3 includes, sequentially from the object side, a biconcave negative lens L31 and a biconvex positive lens L32.

The fourth lens group G4 includes, sequentially from the object side, a cemented positive lens formed by cementing a biconvex positive lens L41 and a negative meniscus lens L42 having a concave surface facing the object side, a biconvex positive lens L43, a cemented negative lens formed by cementing a biconvex positive lens L44 and a biconcave negative lens L45, and an aspheric negative lens L46 in a biconcave negative lens shape formed with an aspheric lens surface on the object side and an aspheric lens surface on the image plane side.

In the zoom optical system ZL4, the space between adjacent lens groups changes at zooming from the wide-angle end state to the telephoto end state. Moreover, in the zoom optical system ZL4, at zooming, the first lens group G1 is fixed relative to an image plane I, and the second lens group G2, the third lens group G3, and the fourth lens group G4 move along the optical axis.

In the zoom optical system ZL4, at focusing on from an infinite distance object to a close distance object, the second lens group G2 moves to the image plane side and the third lens group G3 moves to the object side.

In the zoom optical system ZL4, the aperture stop S is disposed on the object side of the third lens group G3 and moves along the optical axis together with the third lens group G3 at zooming and focusing.

Table 10 below shows values of specifications of the zoom optical system ZL4.

TABLE 10
Fourth example

| | [Overall specifications] | | |
|---|---|---|---|
| | Wide-angle | Intermediate | Telephoto |
| | end | focal length | end |
| f | =18.500 | ~28.005 | ~48.404 |
| Fno | =2.185 | ~2.751 | ~4.120 |
| ω[°] | =50.767 | ~37.878 | ~23.996 |
| Y | =20.889 | ~21.700 | ~21.700 |
| TL(air-conversion | =143.391 | ~143.391 | ~143.391 |
| length) | | | |
| Bf(air-conversion | =24.159 | ~35.193 | ~57.555 |
| length) | | | |

[Lens data]

| m | r | d | nd | νd | |
|---|---|---|---|---|---|
| Object plane | ∞ | D0 | | | |
| 1* | 157.2879 | 3.000 | 1.74310 | 49.44 | |
| 2* | 22.0380 | 16.576 | | | |
| 3 | −199.2673 | 2.000 | 1.59319 | 67.90 | |
| 4 | 25.5366 | 7.872 | 1.73037 | 32.23 | |
| 5 | 99.6228 | D5 | | | |
| 6* | 43.3190 | 1.100 | 1.80810 | 22.76 | |
| 7 | 32.2106 | 4.322 | 1.62263 | 58.16 | |
| 8 | −225.4283 | D8 | | | |
| 9 | ∞ | 3.496 | | | Aperture |
| | | | | | stop S |
| 10 | −34.4195 | 1.247 | 1.77250 | 49.50 | |
| 11 | 603.2210 | 0.200 | | | |
| 12 | 55.8216 | 3.500 | 1.68893 | 31.16 | |
| 13 | −100.0706 | D13 | | | |
| 14 | 30.7766 | 8.643 | 1.59282 | 68.62 | |
| 15 | −36.1075 | 1.000 | 2.00272 | 19.32 | |
| 16 | −116.9050 | 0.238 | | | |
| 17 | 31.0442 | 6.556 | 1.49731 | 82.51 | |
| 18 | −76.9724 | 0.100 | | | |
| 19 | 3216.6555 | 5.257 | 1.94594 | 17.98 | |
| 20 | −27.0690 | 1.000 | 2.00330 | 28.27 | |
| 21 | 1357.0901 | 5.237 | | | |
| 22* | −74.9653 | 1.600 | 1.95150 | 29.83 | |
| 23* | 69.0499 | Bf | | | |
| Image plane | ∞ | | | | |

[Focal length of lens groups]

| Lens group | First surface | Focal length |
|---|---|---|
| First lens group G1 | 1 | −27.114 |
| Second lens group G2 | 6 | 64.115 |
| Third lens group G3 | 9 | −252.229 |
| Fourth lens group G4 | 14 | 44.503 |

In the zoom optical system ZL4, the first surface, the second surface, the sixth surface, the twenty-second surface, and the twenty-third surface are aspheric surfaces. Table 11 below shows aspheric surface data, in other words, the values of the conic constant K and the aspheric surface constants A4 to A12 for the surface number.

TABLE 11
[Aspheric surface data]
First surface

| | | |
|---|---|---|
| K = 1 | | |
| A4 = 5.19274E−06 | A6 = −1.00509E−08 | A8 = 1.02480E−11 |
| A10 = −5.31168E−15 | A12 = 1.19070E−18 | |

Second surface

| | | |
|---|---|---|
| K = 1 | | |
| A4 = 1.28094E−05 | A6 = 1.20928E−11 | A8 = 2.73339E−12 |
| A10 = −4.51231E−14 | A12 = 9.30290E−17 | |

Sixth surface

| | | |
|---|---|---|
| K = 1 | | |
| A4 = −1.06769E−06 | A6 = −1.76220E−09 | A8 = 9.37521E−12 |
| A10 = −5.63577E−14 | A12 = 1.14190E−16 | |

Twenty-second surface

| | | |
|---|---|---|
| K = 1 | | |
| A4 = −9.16321E−05 | A6 = 8.51953E−07 | A8 = −5.15501E−09 |
| A10 = 1.88158E−11 | A12 = −3.03680E−14 | |

Twenty-third surface

| | | |
|---|---|---|
| K = 1 | | |
| A4 = −5.49884E−05 | A6 = 8.85063E−07 | A8 = −5.14130E−09 |
| A10 = 1.86307E−11 | A12 = −2.95090E−14 | |

In the zoom optical system ZL4, an on-axis air space D5 between the first lens group G1 and the second lens group G2, an on-axis air space D8 between the second lens group G2 and the third lens group G3, an on-axis air space D13 between the third lens group G3 and the fourth lens group G4, and the back focus Bf change at zooming and focusing. Table 12 below shows variable spaces in the wide-angle end state, the intermediate focal length state, and the telephoto end state at focusing on an infinite distance object and at focusing on a close distance object.

TABLE 12
[Variable space data]

| | Infinity | | | Close distance object | | |
|---|---|---|---|---|---|---|
| | Wide- | | | Wide- | | |
| | angle | Inter- | Telephoto | angle | Inter- | Telephoto |
| | end | mediate | end | end | mediate | end |
| f | 18.500 | 28.005 | 48.404 | — | — | — |
| β | — | — | — | −0.033 | −0.033 | −0.033 |
| D0 | ∞ | ∞ | ∞ | 519.839 | 808.763 | 1422.941 |
| D5 | 27.325 | 12.324 | 0.974 | 28.665 | 13.186 | 1.485 |
| D8 | 5.785 | 18.263 | 10.258 | 3.707 | 17.185 | 9.491 |
| D13 | 13.178 | 4.667 | 1.660 | 13.915 | 4.883 | 1.916 |
| Bf | 24.159 | 35.193 | 57.555 | 24.159 | 35.193 | 57.555 |

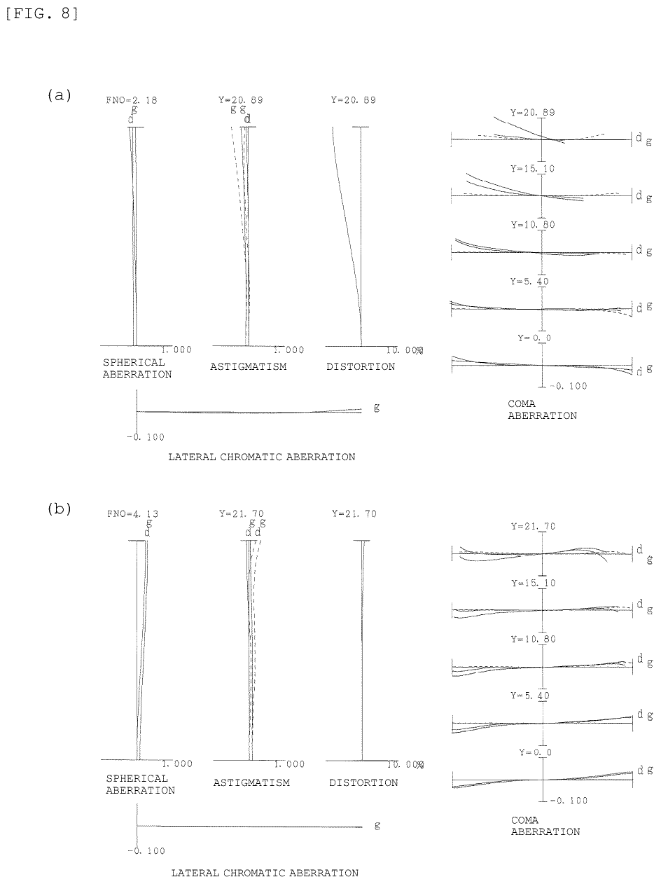

FIG. 8 shows a spherical aberration diagram, an astigmatism diagram, a distortion diagram, a lateral chromatic aberration diagram, and a coma aberration diagram of the zoom optical system ZL4 at focusing on an infinite distance object in the wide-angle end state and the telephoto end state. The aberration diagrams show that the zoom optical system ZL4 allows favorable correction of the variety of aberrations and has excellent imaging performance.

### [Conditional Expression Correspondence Value]

Table 13 below shows correspondence values of Conditional Expression (1) to (10) in the first to fourth examples.

TABLE 13

| | |
|---|---|
| (1) | (−f1)/f2 |
| (2) | ft/Bft |
| (3) | (−f1)/\|f3\| |
| (4) | f4/f2 |
| (5) | f4/\|f3\| |
| (6) | (−f1)/f4 |
| (7) | f2/\|f3\| |
| (8) | ft/TL |
| (9) | fw/Bfw |
| (10) | ft/TLGt |

| | First | Second | Third | Fourth |
|---|---|---|---|---|
| | example | example | example | example |
| TLGt | 123.699 | 129.523 | 80.598 | 85.836 |
| (1) | 0.216 | 0.241 | 0.506 | 0.423 |
| (2) | 0.951 | 0.973 | 0.823 | 0.841 |
| (3) | 0.205 | 0.154 | 0.164 | 0.107 |
| (4) | 0.445 | 0.475 | 0.854 | 0.694 |
| (5) | 0.422 | 0.304 | 0.277 | 0.176 |
| (6) | 0.485 | 0.508 | 0.592 | 0.609 |
| (7) | 0.948 | 0.640 | 0.324 | 0.254 |
| (8) | 0.213 | 0.207 | 0.348 | 0.338 |
| (9) | 1.581 | 1.593 | 0.768 | 0.766 |
| (10) | 0.275 | 0.263 | 0.601 | 0.564 |

### REFERENCE SIGNS LIST

1 camera (optical apparatus)
ZL (ZL1 to ZL4) zoom optical system
G1 first lens group
G2 second lens group
G3 third lens group
G4 fourth lens group

1. A zoom optical system comprising, sequentially from an object side:
a first lens group having negative refractive power;
a second lens group having positive refractive power;
a third lens group; and
a fourth lens group having positive refractive power, wherein
a space between adjacent lens groups changes at zooming, with the first lens group fixed relative to an image plane and the fourth lens group moving along an optical axis,
at least the second lens group moves along the optical axis at focusing, and
the zoom optical system satisfies a condition expressed by expressions below,
$$0.05 < ( - f 1 ) / f 2 < 1.5$$
$$0.1 < ft / Bft < 1.5$$
in the expressions,
f1: focal length of the first lens group,
f2: focal length of the second lens group,
ft: overall focal length of the zoom optical system in a telephoto end state, and
Bft: back focus of the zoom optical system in the telephoto end state.

2. A zoom optical system comprising, sequentially from an object side:
a first lens group having negative refractive power;
a second lens group having positive refractive power;
a third lens group; and
a fourth lens group having positive refractive power, wherein
a space between adjacent lens groups changes at zooming, with the first lens group fixed relative to an image plane and the fourth lens group moving along an optical axis,
at least the second lens group moves along the optical axis at focusing, and
the zoom optical system satisfies a condition expressed by expressions below,
$$0.01 < ( - f 1 ) / \vert f 3 \vert < 1.$$
$$0. 100 < f 4 / f 2 < 1.2$$
in the expressions,
f1: focal length of the first lens group,
f2: focal length of the second lens group,
f3: focal length of the third lens group, and
f4: focal length of the fourth lens group.

3. The zoom optical system according to claim 1, wherein the zoom optical system satisfies a condition expressed by an expression below,
$$0.01 < ( - f 1 ) / \vert f 3 \vert < 1.$$
in the expression,
f1: focal length of the first lens group, and
f3: focal length of the third lens group.

4. The zoom optical system according to claim 1, wherein the zoom optical system satisfies a condition expressed by an expression below,
$$0.1 < f 4 / f 2 < 1.2$$
in the expression,
f2: focal length of the second lens group, and
f4: focal length of the fourth lens group.

5. The zoom optical system according to claim 1, wherein the zoom optical system satisfies a condition expressed by an expression below,
$$0.01 < f 4 / \vert f 3 \vert < 1.$$
in the expression,
f3: focal length of the third lens group, and
f4: focal length of the fourth lens group.

6. The zoom optical system according to claim 1, wherein the zoom optical system satisfies a condition expressed by an expression below,
$$0. 150 < ( - f 1 ) / f 4 < 1.5$$
in the expression,
f1: focal length of the first lens group, and
f4: focal length of the fourth lens group.

7. The zoom optical system according to claim 1, wherein the zoom optical system satisfies a condition expressed by an expression below,
$$0.01 < f 2 / \vert f 3 \vert < 2.$$
in the expression,
f2: focal length of the second lens group, and
f3: focal length of the third lens group.

8. The zoom optical system according to claim 1, wherein the zoom optical system satisfies a condition expressed by an expression below,
$$0.01 < ft / TL < 1.$$
in the expression,
ft: overall focal length of the zoom optical system in a telephoto end state, and
TL: optical total length of the zoom optical system.

9. The zoom optical system according to claim 1, wherein the zoom optical system satisfies a condition expressed by an expression below,
$$0.3 0 < fw / Bfw < 4.000$$
in the expression,
fw: overall focal length of the zoom optical system in a wide-angle end state, and
Bfw: back focus of the zoom optical system in a wide-angle end state.

10. The zoom optical system according to claim 1, wherein the zoom optical system satisfies a condition expressed by an expression below,
$$0.1 < ft / TLGt < 1.$$
in the expression,
ft: overall focal length of the zoom optical system in a telephoto end state, and
TLGt: distance on the optical axis from a lens surface closest to an object side to a lens surface closest to an image plane side in the zoom optical system in the telephoto end state.

11. The zoom optical system according to claim 1, wherein the third lens group has positive refractive power.

12. The zoom optical system according to claim 1, wherein the second lens group is constituted by one lens component.

13. The zoom optical system according to claim 1, wherein the second lens group is constituted by one positive lens and one negative lens.

14. An optical apparatus comprising the zoom optical system according to claim 1.

15. A method for manufacturing a zoom optical system including, sequentially from an object side, a first lens group having negative refractive power, a second lens group having positive refractive power, a third lens group, and a fourth lens group having positive refractive power, the method comprising:
disposing the lens groups so that an space between adjacent lens groups changes at zooming, with the first lens group fixed relative to an image plane and the fourth lens group moving along an optical axis;
disposing the lens groups so that at least the second lens group moves along the optical axis at focusing; and
disposing the lens groups so that a condition expressed by an expression below is satisfied,
$$0.05 < ( - f 1 ) / f 2 < 1.5$$
$$0.1 < ft / Bft < 1.5$$
in the expressions,
f1: focal length of the first lens group,
f2: focal length of the second lens group,
ft: overall focal length of the zoom optical system in a telephoto end state, and
Bft: back focus of the zoom optical system in the telephoto end state.

16. (canceled)

17. The zoom optical system according to claim 2, wherein the zoom optical system satisfies a condition expressed by an expression below,
$$0.01 < f 4 / \vert f 3 \vert < 1.$$
in the expression,
f3: focal length of the third lens group, and
f4: focal length of the fourth lens group.

18. The zoom optical system according to claim 2, wherein the zoom optical system satisfies a condition expressed by an expression below,
$$0. 150 < ( - f 1 ) / f 4 < 1.5$$
in the expression,
f1: focal length of the first lens group, and
f4: focal length of the fourth lens group.

19. The zoom optical system according to claim 2, wherein the zoom optical system satisfies a condition expressed by an expression below,
$$0.01 < f 2 / \vert f 3 \vert < 2.$$
in the expression,
f2: focal length of the second lens group, and
f3: focal length of the third lens group.

20. The zoom optical system according to claim 2, wherein the zoom optical system satisfies a condition expressed by an expression below,
$$0.01 < ft / TL < 1.$$
in the expression,
ft: overall focal length of the zoom optical system in a telephoto end state, and
TL: optical total length of the zoom optical system.

21. The zoom optical system according to claim 2, wherein the zoom optical system satisfies a condition expressed by an expression below,
$$0.1 < ft / TLGt < 1.$$
in the expression,
ft: overall focal length of the zoom optical system in a telephoto end state, and
TLGt: distance on the optical axis from a lens surface closest to an object side to a lens surface closest to an image plane side in the zoom optical system in the telephoto end state.

22. An optical apparatus comprising the zoom optical system according to claim 2.
